(19) United States
(12) Patent Application Publication
(10) Pub. No.: US 2010/0077990 A1
(43) Pub. Date: Apr. 1, 2010

(54) CONTROL OF SPARK IGNITED INTERNAL COMBUSTION ENGINE

(75) Inventors: Kouji Shishime, Hiroshima-shi (JP); Naoya Matsuo, Higashihiroshima-shi (JP); Masahisa Yamakawa, Hiroshima-shi (JP); Tatsuya Fujikawa, Hiroshima-shi (JP); Takashi Youso, Hiroshima-shi (JP); Toshiaki Nishimoto, Hiroshima-shi (JP); Naohiro Yamaguchi, Hiroshima-shi (JP); Mikinori Ohashi, Hiroshima-shi (JP)

Correspondence Address: ALLEMAN HALL MCCOY RUSSELL & TUTTLE LLP, 806 SW BROADWAY, SUITE 600, PORTLAND, OR, 97205-3335, US

(73) Assignee: Mazda Motor Corporation, Hiroshima (JP)

(21) Appl. No.: 12/566,561

(22) Filed: Sep. 24, 2009

(30) Foreign Application Priority Data
Sep. 26, 2008 (JP) 2008-247541

(51) Int. Cl. F02B 3/00; F02D 41/30

(52) U.S. Cl. 123/299; 701/104

(57) ABSTRACT

There is provided a method of controlling a spark ignited internal combustion engine having a fuel injector which injects fuel directly into its combustion chamber. The method comprises injecting a total amount of fuel into a combustion chamber by early in a compression stroke during a cylinder cycle at a first engine speed. The method further comprises injecting a first stage of fuel into the combustion chamber during a cylinder cycle by an early in a compression stroke of the cylinder cycle, and injecting a second stage of fuel by late in the compression stroke during the cylinder cycle at a second engine speed less than the first engine speed, after injecting the first stage of fuel. The amount of the second stage fuel is greater than an amount of said first stage fuel. Accordingly, the first and second stage fuels may not be pre-ignited before the spark ignition.

### BACKGROUND

The present description relates to control of a spark ignited internal combustion engine having a fuel injector which directly injects fuel into the combustion chamber.

To improve efficiency of an internal combustion engine, particularly for an automotive vehicle, it is preferred that the engine have a high geometric compression ratio. However, an increased compression ratio may cause increased combustion chamber temperatures. A higher temperature in the combustion chamber may cause abnormal combustion such as knocking or pre-ignition.

Knocking occurs after spark ignition. In particular, the spark starts combustion of air fuel mixture in the combustion chamber, and the combusted gas expands and compresses the un-combusted air fuel mixture. As the temperature of the compressed air fuel mixture rises, the un-combusted air fuel mixture ignites itself when the gas temperature reaches the ignition temperature.

On the other hand, pre-ignition occurs before spark ignition. Specifically, an air fuel mixture is compressed, and as the mixture is compressed, its temperature rises during the compression stroke. If the gas temperature reaches the ignition temperature before a spark occurs, the whole air fuel mixture ignites. Therefore, since the combusted gas is expanding in the compression stroke, pre-ignition may cause higher pressure in the combustion chamber than knocking.

There is known, and for example described in US2007/0227503A1, a divisional fuel injection method which injects a first stage fuel in the intake stroke and a second stage fuel in the compression stroke during a cylinder cycle. The second stage fuel is injected into the compressed, relatively hot air fuel mixture, and cools the gas mixture by using some of the heat in the gas to vaporize the fuel. Therefore, it can decrease the temperature in the combustion chamber and reduce the possibility of abnormal combustion.

The prior method can reduce the possibility of knocking, but it still does not significantly reduce the possibility of pre-ignition in a spark ignited internal combustion engine having a relatively high compression ratio. Therefore, there is room to improve the prior divisional fuel injection method.

### SUMMARY

The inventors herein have rigorously studied ways to suppress the possibility of pre-ignition and have developed a unique method to reduce the possibility of pre-ignition.

Accordingly, there is provided, in one aspect of the present description, a method of controlling a spark ignited internal combustion engine having a fuel injector which injects fuel directly into a combustion chamber. The method comprises injecting a total amount of fuel into a combustion chamber during a cylinder cycle, the total amount of fuel injected by early in a compression stroke of the cylinder cycle at a first engine speed. The method further comprises injecting a first stage of fuel in the combustion chamber during a cylinder cycle, the first stage of fuel injected by early in a compression stroke of a cylinder cycle, and injecting a second stage of fuel, after injecting the first stage of fuel, the second stage of fuel injected by late in the compression stroke during the cylinder cycle at a second engine speed that is less than the first engine speed. And, the amount of the second stage fuel is greater than the amount of the first stage fuel.

According to the first aspect, when the engine speed is relatively low, the second stage fuel is injected late in the compression stroke. The second stage fuel receives heat from a combustion chamber wall such as a cylinder wall, a piston top and a cylinder ceiling during a period between the injection and the ignition. The heat receiving period starts late in the compression stroke; therefore, the heat receiving period is shorter, and the heat received by the second stage fuel is reduced. Then, the molecules of the second stage fuel are in less motion such that they do not collide with the oxygen molecules fast enough to ignite. Consequently, the possibility of pre-ignition of the second stage fuel is reduced.

In the same occasion, the first stage fuel is injected much earlier than the second stage fuel is injected, and it receives more heat from the combustion chamber wall and is more likely to cause a pre-ignition. However, the amount of the first stage fuel is less than the amount of the second stage fuel. Therefore, less of the fuel molecules collide with the oxygen molecules and the exothermal reaction caused by the molecular collision causes less heat. As a result, a temperature of the first stage fuel is temporarily decreased at the injection timing of the second stage fuel and does not reach the ignition temperature before the spark ignition. Consequently, there is a reduced possibility of pre-igniting the first and second stage fuels before the spark ignition.

Even though the heat receiving period of the second stage fuel is short enough to suppress the pre-ignition of the second stage fuel, it is long enough to atomize/evaporate the second stage fuel since it is done when the engine speed is relatively low.

On the other hand, when the engine speed is relatively high, the heat receiving period is shorter and the possibility of abnormal combustion is reduced. Therefore, it is possible to complete the fuel injection by early in the compression stroke. This leads to there being enough time to atomize or evaporate the fuel.

There is provided, in a second aspect of the present description, a system comprising a spark ignited internal combustion engine, a fuel injector which injects fuel directly into a combustion chamber, and a controller. The controller is configured to control the fuel injector to inject a total amount of fuel into the combustion chamber during a cylinder cycle, the total amount of fuel injected by early in a compression stroke of said cylinder cycle at a first engine speed. The controller is further configured to control the fuel injector to inject a first stage of fuel into the combustion chamber during a cylinder cycle, the first stage of fuel injected by early in a compression stroke of the cylinder cycle, and injecting a second stage of fuel, after injecting the first stage of fuel, the second stage of fuel injected by late in the compression stroke during the cylinder cycle at a second engine speed, the second engine speed less than the first engine speed. Further, a desired torque of said engine is greater than a predetermined torque when the first stage fuel and second stage fuel are injected. Further still, the amount of the second stage fuel is greater than amount of the first stage fuel.

The system according to the second aspect performs the method according to the first aspect. Therefore, the system can advantageously suppress the possibility of occurrence of pre-ignition.

In embodiments, a ratio of the amount of the second stage fuel relative to the total amount of the first and second stage fuel may be decreased as an engine speed of the engine increases so as to secure enough time to evaporate the injected fuel.

In other embodiments, a ratio of the amount of the second stage fuel relative to the total amount of the first and second stage fuel may be increased as the desired torque of the engine increases or as a temperature in the combustion chamber increases. As such, the method can suppress the possibility of occurrence of the pre-ignition in a situation where more of the fuel molecules may collide with the oxygen molecules or the collision may be faster.

In addition, in other embodiments, a negative valve overlap period may be decreased, for example, by opening the intake valve earlier during a cylinder cycle, as the desired engine torque increases so as to induct more fresh air into the combustion chamber to increase engine torque.

In still other embodiments, the injected fuel may be ignited with a spark after a top dead center of the compression stroke during the cylinder cycle when the second stage fuel is injected so as to suppress the possibility of the occurrence of knocking in addition to suppressing the possibility of pre-ignition. The fuel is injected at a first pressure when the fuel injection is completed by early in the compression stroke during the cylinder cycle, and the fuel is injected at a second pressure when the second stage fuel is injected. The second pressure may be greater than the first pressure so as to enhance the evaporation/atomization of the second stage fuel which is injected in the highly pressurized gas and at a time closer to the ignition timing.

In still other embodiments, the intake valve may be opened after closing the exhaust valve, and the first stage fuel may be injected after the opening the intake valve, thereby enhancing the evaporation/atomization of the first stage fuel. Later intake valve opening increases vacuum in the cylinder before the intake valve opens, and as a result, the flow rate of air entering the cylinder increases when the intake valve opens.

In still other embodiments, the spark ignited internal combustion engine may have a geometric compression ratio of 14 or greater so that an engine operating efficiency at a condition where the abnormal combustion is not likely to occur can be improved.

In still other embodiments, the spark ignited internal combustion engine may have a turbocharger or a mechanical supercharger to increase air charge in the cylinder so that an engine output torque increases without increasing the possibility of the pre-ignition.

### BRIEF DESCRIPTION OF THE DRAWINGS

The advantages described herein will be more fully understood by reading an example of embodiments in which the above aspects are used to advantage, referred to herein as the Detailed Description, with reference to the drawings wherein:

FIG. 1 is a schematic view showing a spark ignition internal combustion engine according to an embodiment of the present description;

FIG. 2 shows a flowchart of routine R1 executed by an engine controller 100 of FIG. 1;

FIG. 3 shows a flowchart of routine R2 executed by the engine controller 100 of FIG. 1;

FIG. 4 shows a diagram illustrating a target phase of an intake camshaft phase adjusting mechanism 32 of FIG. 1;

FIG. 5 shows a diagram illustrating a valve overlap profile between intake and exhaust valves 21 and 22 of FIG. 1;

FIG. 6 shows an operational map of fuel injection in accordance with the embodiment;

FIG. 7 shows diagrams illustrating states of operation of the intake valve, exhaust valve, fuel injection and spark ignition in accordance with the embodiment;

FIG. 8 shows a diagram illustrating a profile of fuel division ratios with respect to the engine speed and target air charge;

FIG. 9 shows a diagram illustrating a profile of fuel division ratios at a specific engine speed and target air charge condition with respect to an intake air temperature; and

FIG. 10 is a graph showing a relationship between a percentage of the second stage fuel to the total amount of the fuel and a greatest effective compression ratio with which the pre-ignition does not occur at a certain condition.

### DETAILED DESCRIPTION

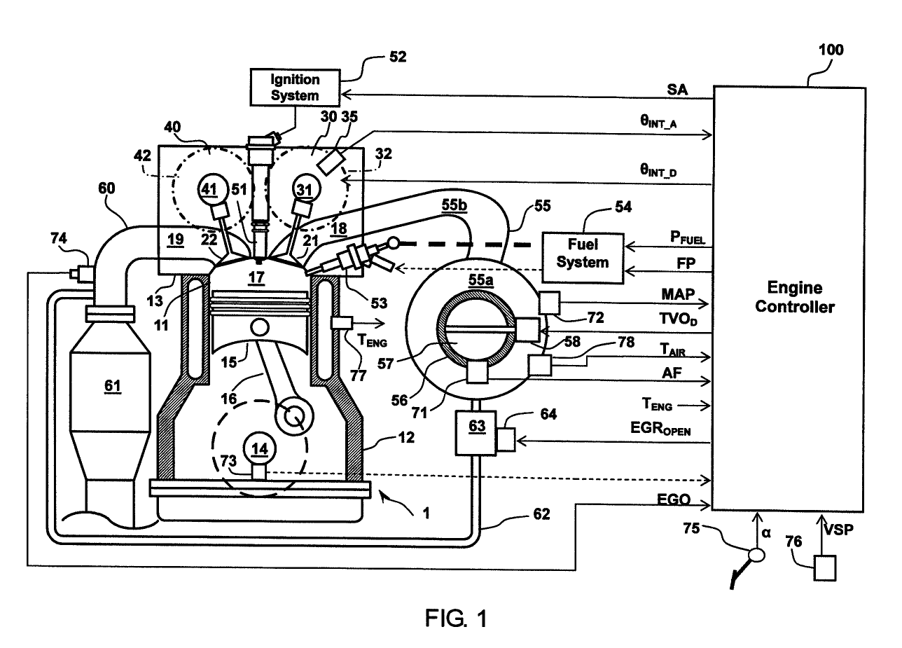

Embodiments of the present description will now be described with reference to the drawings, starting with FIG. 1, which illustrates a schematic diagram of an entire engine system having a spark ignited internal combustion engine 1. The engine system includes an engine main body (internal combustion engine) 1 and an engine controller (control module) 100, which is configured to control various actuators associated with the engine main body 1.

The engine main body 1 is a four-cycle spark-ignited internal combustion engine installed in a vehicle, such as an automobile. An output shaft of the engine main body 1 is coupled to a drive wheel via a transmission in order to drive the vehicle. The engine main body 1 includes a cylinder block 12 and a cylinder head 13 placed thereon. Inside the cylinder block 12 and the cylinder head 13, a plurality of cylinders 11 are formed. The number of cylinders 11 is not limited; however, four cylinders 11 are formed in this embodiment, as one example. Further, in the cylinder block 12, a crankshaft 14 is supported rotatably by a journal, a bearing and the like.

To each of the cylinders 11, a piston 15 is slideably inserted and fitted to connecting rod 16, over which a combustion chamber 17 is laid out.

In this embodiment, a geometric compression ratio of the engine main body 1 is set to approximately 14, which is the ratio of the volume of the combustion chamber 17 when the piston 15 is positioned at the bottom dead center to the volume of the combustion chamber 17 when the piston 15 is positioned at the top dead center. Of course, the value of the geometric compression ratio is not limited to 14. For example, it may be preferable that the geometric compression ratio is higher from the point of view of improving engine efficiency. However, as the geometric compression ratio is set higher, an in-cylinder temperature can become too high in the compression stroke, thereby increasing the possibility of an auto-ignition occurring at an unexpected timing. Therefore, the geometric compression ratio of the engine main body 1 may be, preferably, between 14 and 16, but is not limited to this range, especially if the engine is supercharged or turbocharged.

The cylinder head 13 is formed with two intake ports and two exhaust ports communicating with the respective one of the combustion chambers. In FIG. 1, one intake port 18 and one exhaust port 19 are shown, though two intake ports and two exhaust ports per cylinder are included in this embodiment, as described above. Further, the cylinder head 13 is provided with intake valves 21 blocking the respective intake ports 18 from the combustion chamber 17 and exhaust valves 22 blocking the respective exhaust ports 19 from the combustion chamber 17. The intake valves 21 are driven by an intake valve driving mechanism 30, described later, to open and close the respective intake ports 18 at a predetermined timing. On the other hand, the exhaust valves 22 are driven by an exhaust valve driving mechanism 40 to open and close the respective exhaust ports 19.

The intake valve driving mechanism 30 and the exhaust valve driving mechanism 40 have an intake camshaft 31 and an exhaust camshaft 41, respectively. The intake camshaft 31 and the exhaust camshaft 41 are coupled to the crankshaft 14 via a power transmission mechanism such as a known chain-sprocket mechanism. The power transmission mechanism is configured such that the camshafts 31 and 41 rotate one time while the crankshaft 14 rotates two times.

Further, in the intake valve driving mechanism 30, there is provided an intake camshaft phase changing mechanism 32 between the power transmission mechanism and the intake camshaft 31. The intake camshaft phase changing mechanism 32 is set to change the valve timing of the intake valve 21, in which a phase difference between the crankshaft 14 and the intake camshaft 31 is changed by changing the phase difference between the driven shaft, which is arranged concentrically with the intake camshaft 31 and is directly driven by the crankshaft 14, and the intake camshaft 31.

The intake camshaft phase changing mechanism 32 includes, for example, a hydraulic pressure mechanism where a plurality of liquid holding chambers are arranged in a circumferential direction between the driven shaft and the intake camshaft 31. A pressure difference between the liquid holding chambers is used to change the phase difference. An electromagnetic mechanism having an electromagnet is provided between the driven shaft and the intake camshaft 31. Current is applied to the electromagnet to change the phase difference between the camshaft and the crankshaft. The intake camshaft phase changing mechanism 32 changes the phase difference based on the valve timing of the intake valve 21 calculated by the engine controller 100, described later.

In this embodiment, the intake camshaft phase changing mechanism 32 changes the valve opening timing IVO and valve closing timing IVC of the intake valve 21 by changing the phase difference. The lift amount (i.e., a valve profile of the intake valve 21) is kept constant. A phase angle of the intake camshaft 31 is detected by a cam phase sensor 35, and a signal θ_{INT}_{_{—}}_{A} thereof is transmitted to the engine controller 100.

Also, in the exhaust valve driving mechanism 40, there is provided an exhaust camshaft phase changing mechanism 42 between the power transmission mechanism and the intake camshaft 41. The exhaust camshaft phase changing mechanism changes the valve opening timing EVO and valve closing timing EVC of the exhaust valve 22 in the same manner as in the intake camshaft phase changing mechanism.

The intake port 18 communicates with a surge tank 55a via an intake manifold 55b. The air intake passage upstream of the surge tank 55a is provided with the throttle body (throttle valve actuator) 56. A throttle valve 57 is pivotally provided inside the throttle body 56 for adjusting the air flowing from atmosphere to the surge tank 55a. The throttle valve 57 can change the opening area of the air intake passage (i.e., the flow passage area) to change the mass air flow rate, and the pressure in the air intake passage downstream of the throttle valve 57. The throttle valve 57 is actuated by a throttle valve actuator 58. The throttle valve actuator 58 actuates the throttle valve 57 such that the opening TVO of the throttle valve 57 is to be a target throttle valve opening TVO_{D} calculated in the engine controller 100. Here, the air intake passage 55 may include all of the intake port 18, the intake manifold 55b and the surge tank 55a downstream of the throttle valve 57. In this embodiment, an amount of air to be inducted into the cylinder 11, that is, the air charge amount CE inside the cylinder 11 is controlled to have an adequate value by adjusting the opening of the throttle valve 57 and the closing timing of the intake valve 21.

The exhaust port 19 communicates with an exhaust pipe via an exhaust manifold 60. In the exhaust pipe, an exhaust gas treatment system is arranged. A specific constitution of the exhaust gas treatment system is not limited to, but may include those having a catalytic converter 61 of a three-way catalyst, a lean NOx catalyst, an oxidation catalyst and the like.

The surge tank 55a and the exhaust manifold 60 communicate with each other via an EGR pipe 62, constituted such that a part of the exhaust gas may be circulated to an intake side. Provided in the EGR pipe 62 is an EGR valve 63 for adjusting the flow volume of EGR gas circulating to the intake side through the EGR pipe 62. The EGR valve 63 is actuated by an EGR valve actuator 64. The EGR valve actuator 64 actuates the EGR valve 63 such that the opening of the EGR valve 63 becomes an EGR opening EGRₒₚₑₙ calculated by the engine controller 100. This makes it possible to adjust the flow volume of the EGR gas to an adequate value.

The cylinder head 13 has spark plugs 51 attached thereto such that a tip of each spark plug faces the combustion chamber 17. The spark plug 51 generates a spark in the combustion chamber 17 when supplied with current by an ignition system 52, based on an ignition timing signal SA output from the engine controller 100, described later in detail.

Further, the cylinder head 13 has fuel injectors 53 attached thereto for injecting fuel directly into the respective combustion chambers 17 such that a tip of each of the fuel injectors faces the combustion chamber 17. In more detail, the fuel injector 53 is arranged such that the tip thereof is positioned below the two intake ports 18 in a vertical direction, and midway between the two intake ports 18 in a horizontal direction. The fuel injector 53 injects a predetermined amount of fuel into the combustion chamber 17 when a solenoid coupled to the fuel injector 53 is supplied with current by a fuel system 54 for a predetermined period of time based on a fuel pulse signal FP calculated by and output from the engine controller 100. The fuel system 54 includes a pressure regulator and supplies fuel to the fuel injectors 53 at a fuel pressure in accordance with a fuel pressure signal P_{FUEL} calculated by and output from the engine controller 100.

The engine controller 100 is a controller having a known microcomputer as a base and includes a CPU for executing a program, a memory such as RAM and ROM for storing a program and data, and an I/O bus for inputting and outputting various signals.

The engine controller 100 receives inputs via the I/O bus, with various information such as an intake airflow AF detected by an air flow meter 71, an air pressure MAP inside the surge tank 55a detected by an intake pressure sensor 72, a crank angle pulse signal detected by a crank angle sensor 73, an oxygen concentration EGO of the exhaust gas detected by an oxygen concentration sensor 74, an amount a of depression of an accelerator pedal by a driver of the automobile detected by an accelerator pedal position sensor 75, a vehicle speed VSP detected by a vehicle speed sensor 76, an engine temperature T_{ENG} detected by an engine coolant temperature sensor 77, and an intake air temperature T_{AIR} detected by an intake air temperature sensor which detects a temperature inside the surge tank 55a or a temperature upstream of the throttle body 56. Then, the engine controller 100 calculates control parameters for various actuators such that the air charge amount, ignition timing and the like in cylinder 11 may be an appropriate value according to the operating conditions based on the input information. For example, control parameters such as a throttle valve opening TVO, the fuel injection amount FP, the fuel pressure P_{FUEL}, the ignition timing SA, a target value of the intake valve timing θ_{INT}_{_{—}}_{D} and the EGR opening EGRₒₚₑₙ are calculated and output to the throttle valve actuator 58, the fuel system 54, the ignition system 52, the intake camshaft phase changing mechanism 32, the EGR valve actuator 64 and the like.

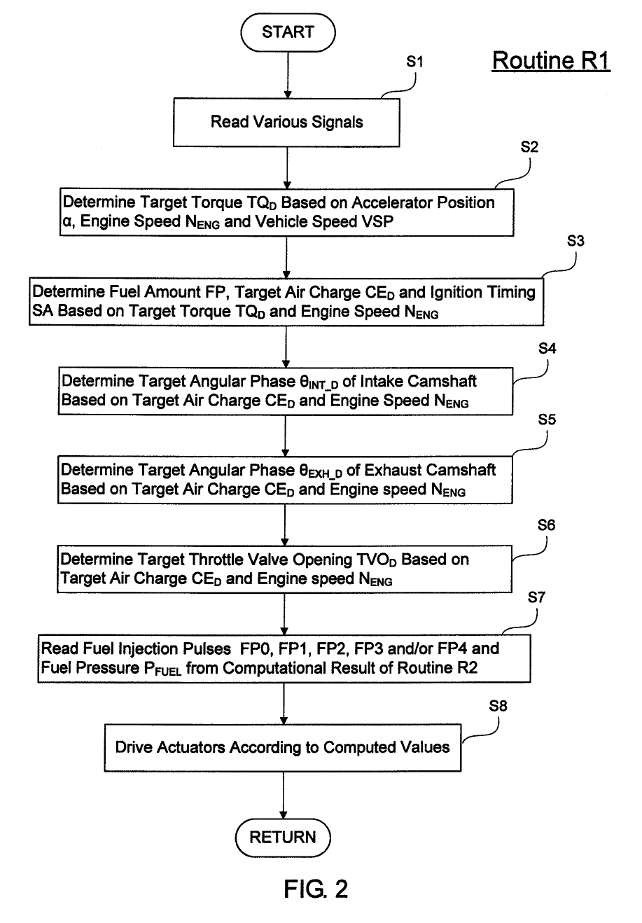

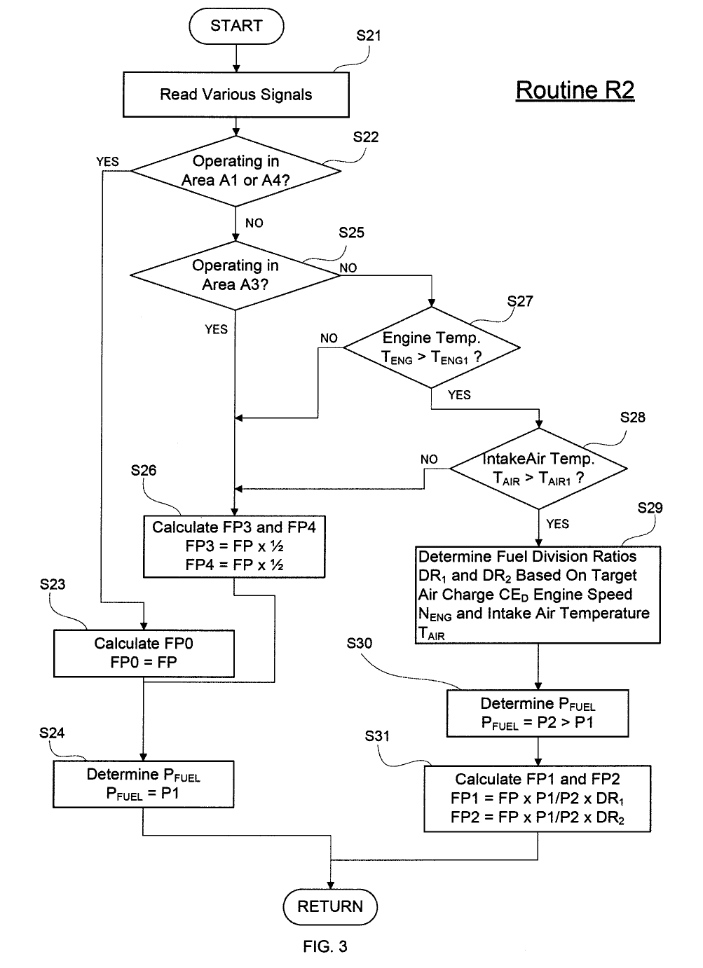

Control routines the engine controller 100 executes will be described with reference to flowcharts illustrated in FIGS. 2 and 3.

Referring to FIG. 2, there is shown a flowchart of a first routine R1 for the engine controller 100 to input and output signals with the various devices described above. After the start, at a step S1, the first routine R1 reads various signals such as the accelerator position α. It proceeds to a step S2 and determines a target torque TQ_{D} based on the accelerator pedal position α, the engine speed N_{ENG} of the engine 1 (calculated from the crank angle pulse signal) and the vehicle speed VSP. After step S2, routine R1 proceeds to a step S3 and determines a fuel amount FP, a target air charge CE_{D} (a target value of the air charge amount CE in the cylinder 11) and an ignition timing SA based on the target torque TQ_{D} and engine speed N_{ENG}. The fuel amount FP and target air charge CE_{D} are determined to increase as the target torque TQ_{D} increases.

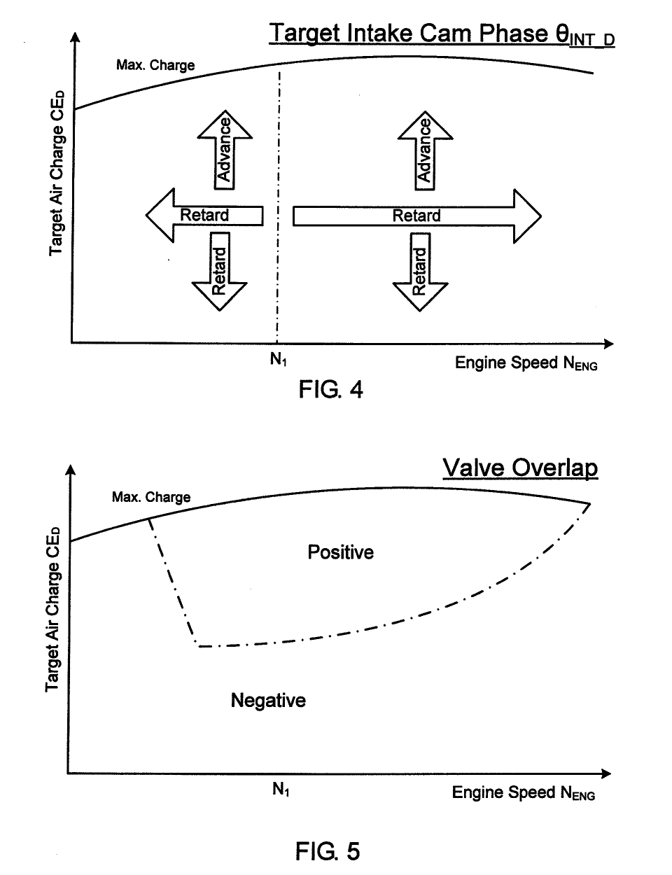

Then, the first routine R1 proceeds to a step S4 and determines a target angular phase θ_{INT}_{_{—}}_{D} of the intake camshaft 31 based on the target air charge CE_{D} and the engine speed N_{ENG} determined in a step S3 by reading data in a table expressed by a map illustrated in FIG. 4. Therein, the target angular phase θ_{INT}_{_{—}}_{D} of the intake camshaft 31 is set to retard as the engine speed N_{ENG} increases when it is greater than a predefined speed N1. In contrast, when the engine speed N_{ENG} is less than the predefined speed N1, the target angular phase θ_{INT}_{_{—}}_{D} retards as the engine speed decreases.

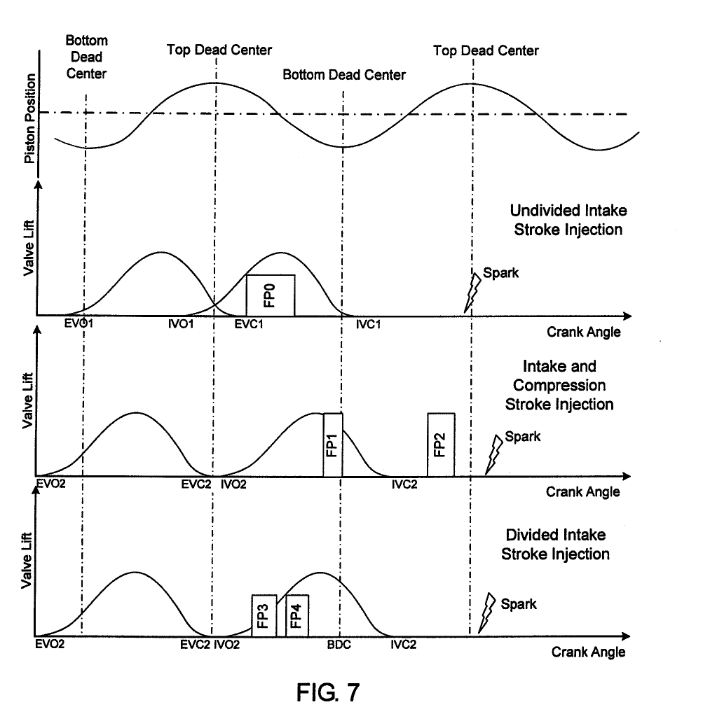

On the other hand, as the target air charge CE_{D} increases, the target angular phase θ_{INT}_{_{—}}_{D} advances. Therefore, at a higher target charge CE_{D} and a higher engine speed N_{ENG}, the intake valve 21 closes at a timing IVC1 as illustrated in the second top diagram of FIG. 7. For a lower target air charge CE_{D} and a higher engine speed N_{ENG}, the intake valve closes at a timing IVC2 which is later than the timing IVC1 in a cylinder cycle as is illustrated in the bottom diagram of FIG. 7. As a result, at the timing IVC2, the piston is substantially ascended and the air which has been inducted into the combustion chamber 17 is blown back to the intake air passage 18. Therefore, the lower target air charge in the combustion chamber 17 is obtained without substantially closing the throttle valve 57, this causes lower pressure to act on the top of the piston 15 during the intake stroke and leads to pumping losses.

After step S4, the first routine R1 proceeds to a step S5 and determines a target angular phase θ_{EXH}_{_{—}}_{D} of the exhaust camshaft 41 based on the target air charge CE_{D} and the engine speed N_{ENG} determined in step S3. Note that the target angular phase θ_{EXH}_{_{—}}_{D} of the exhaust camshaft 41 may change much less than the target angular phase of the intake camshaft 31. As a result, in one exemplary state where the target air charge CE_{D} is relatively high and engine speed N_{ENG} is relatively high, as is shown in a region labeled “Positive” in a map illustrated in FIG. 5, the exhaust valve 22 opens at a timing EVO1 before bottom dead center and closes at a timing EVC1 after top dead center during a cylinder cycle as shown in the second from the top diagram of FIG. 7. In this state, the intake valve 21 opens at a timing IVO1 before top dead center and closes at a timing IVC1 after bottom dead center during the cylinder cycle. Therefore, the intake valve 21 opens at the timing IVO1 which is before the timing EVC1 at which time the exhaust valve 22 closes. Consequently, there is between timings IVO1 and EVC1, a time in which both intake valve 21 and exhaust valve 22 are opened, this is an overlap period.

In another exemplary state where the target air charge CE_{D} and engine speed N_{ENG} is not in the Positive region, but in a region labeled “Negative” in the map of FIG. 5, the exhaust valve opens at a timing EVO2 before bottom dead center and closes at a timing EVC2 after top dead center during a cylinder cycle, as shown in second from the bottom and bottom diagrams of FIG. 7. In this state, the intake valve 21 opens at a timing IVO2 after top dead center and closes at a timing IVC2 after bottom dead center during the cylinder cycle. Therefore, the intake valve 21 opens at the timing IVO2, which is after the timing EVC2, at which time the exhaust valve 22 closes. Consequently, there is between the timings EVC2 and IVO2, a time in which both the intake valve 21 and the exhaust valve 22 are closed, this is a negative overlap period.

Referring back to FIG. 2, the first routine R1 proceeds to a step S6 and determines a target throttle valve opening TVO_{D} as a target value of the opening TVO of the throttle valve 57 based on the target air charge CE_{D} and the engine speed N_{ENG}. Then, it proceeds to a step S7 and reads pulse widths FP0, FP1, FP2, FP3 and/or FP4 of the fuel injection during a cylinder cycle and a fuel pressure P_{FUEL} from a computational result of a second routine R2 described in greater detail below.

After the step S7, the first routine R1 proceeds to step S8 and drives the respective actuators according to the computed control parameters such as the fuel injection amount FP, the fuel pressure P_{FUEL}, the ignition timing SA, the target intake camshaft phase θ_{INT}_{_{—}}_{D}, and the target throttle valve opening TVO_{D}. Specifically, the signal θ_{INT}_{_{—}}_{D} is outputted to the intake camshaft phase changing mechanism 32. Then, the intake camshaft phase changing mechanism 32 operates such that a phase of the intake camshaft 31 relative to the crankshaft 14 has a value corresponding to θ_{INT}_{_{—}}_{D}. The signal TVO_{D} is outputted to the throttle valve actuator 58. Then, the throttle valve actuator 58 operates such that the opening TVO of the throttle valve 57 has a value corresponding to TVO_{D}. The signals FP0, FP1, etc. and P_{FUEL} are outputted to the fuel system 54. Then, the signal SA is outputted to the ignition system 52. The spark plug 51 produces a spark and an air-fuel mixture is ignited in the combustion chamber 17 at a timing corresponding to SA in the cylinder cycle. This causes the air-fuel mixture, including the required amount of air and fuel, to be ignited and burned at an appropriate timing such that the target torque, determined mainly from the accelerator position α, is generated from the engine 1. After the step S8, the first routine R1 returns.

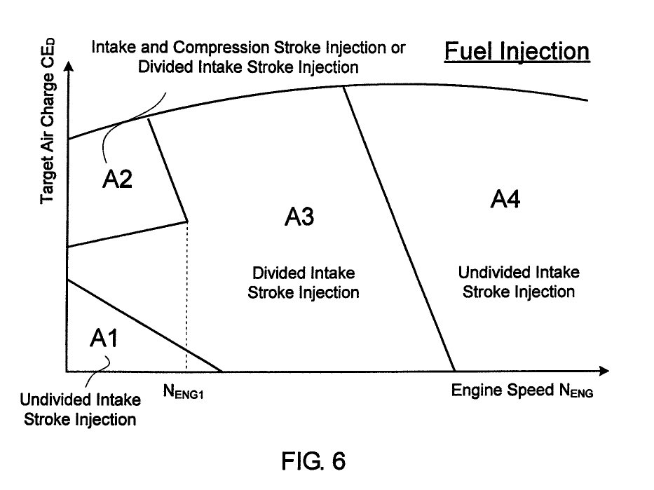

Referring to FIG. 3, there is shown a flowchart illustrating the second routine R2 which is executed for computing the fuel injection pulse widths FP0, FP1, FP2, FP3 and/or FP4 and the fuel pressure P_{FUEL} that are determined in accordance with fuel injection modes in a table illustrated by the diagram of FIG. 6 and read at the step S7 of the first routine R1.

The second routine R2 chooses one of the fuel injection modes in accordance with one of areas A1 through A4 of FIG. 6 in which the engine is operating in response to the desired air charge CE_{D} and engine speed N_{ENG}. Area A1 is provided in a lower target air charge and lower engine speed region. Area A2 is provided in a higher target air charge and lower engine speed region. Area A4 is provided in a higher engine speed region. Area A3 is provided in a region excluding the areas A1, A2 and A4. When the engine operating condition is in the area A1 or A4, an undivided intake stroke fuel injection mode is chosen. When the engine operating condition is in the area A3, a divided intake stroke fuel injection mode is chosen. When the engine operating condition is in the area A2, an intake and compression stroke fuel injection mode or the divided intake stroke fuel injection mode is chosen.

Referring back to FIG. 3, after the start, the second routine R2 proceeds to a step S21 and reads various signals. Then, it proceeds to a step S22 and determines whether or not an engine operating condition determined by the target air charge CE_{D} and engine speed N_{ENG} is in the area A1 or A4 in FIG. 6. If it is determined YES at the step S22, the second routine R2 proceeds to a step S23 and calculates a one-time fuel pulse width FP0 to be equal to the fuel injection amount FP which is determined at the step S3 of the first routine R1. Then, the other fuel pulse widths FP1 through FP4 remain zero. After the step S23, the second routine R2 proceeds to a step S24 and determines a fuel pressure P_{FUEL} to be equal to a lower pressure P1 which is a fixed value and may be, for example, 15 MPa, and it returns. At the step S8 of the first routine R1, the fuel system 54 is controlled to set fuel pressure at the lower pressure P1, and the fuel injector 53 is driven to open its nozzle at a predefined timing after the intake valve 21 opens and to close the nozzle when the pulse width FP0 has passed as illustrated in the second diagram from the top of FIG. 7. Therefore, the system takes the undivided intake stroke injection mode, and the fuel injector 53 injects an amount of fuel that corresponds to the fuel pulse width FP0. The fuel pressure is set at the lower fuel pressure P1 during the intake stroke in a cylinder cycle. The end of the fuel injection is early in the compression stroke, for example, fuel injection ends at the latest position of 140° CA (crank angle) before the top dead center compression stroke, in consideration of evaporation or atomization of the fuel.

When it is determined at step S22 that the engine operating condition is not in the area A1 or A4 (NO), the second routine R2 proceeds to a step S25 and determines whether or not the engine operating condition is in the area A3 of FIG. 6. If it is determined YES at the step S25, the second routine R2 proceeds to a step S26 and calculates third and fourth fuel pulse widths FP3 and FP4 as described below:

FP3=FP×1/2

FP4=FP×1/2.

Then, since the FP3+FP4=FP, the other fuel pulses FP0, FP1 and FP2 remain zero. After the step S26, the second routine R2 proceeds to the step S24 and determines the fuel pressure P_{FUEL} to be the lower pressure P1 as described above. At step S8 of the first routine R1, the fuel system 54 is controlled to set fuel pressure at the lower pressure P1, and the fuel injector 53 is driven to open its nozzle at a predefined timing after the intake valve 21 opens and to close the nozzle when the pulse width FP3 has passed. The injector nozzle is again opened at a predefined timing and closed when the pulse width FP4 has passed as is illustrated in the bottom diagram of FIG. 7. Therefore, the system takes the divided intake stroke injection mode, and the fuel injector 53 twice injects a half amount of fuel that corresponds to the fuel pulse width FP. The fuel pressure is set at the lower fuel pressure P1 during the intake stroke in a cylinder cycle. As in the undivided intake stroke injection mode, the end of the fuel injection is in an early compression stroke, for example, fuel injection ends at the latest position of 140° CA (crank angle) before the top dead center compression stroke, in consideration of evaporation or atomization of the fuel.

When it is determined at the step S25 that the engine operating condition is not in the area A3 of FIG. 6 (NO), in other words, it is in the area A2, the second routine R2 proceeds to a step S27 and determines whether or not the engine temperature T_{ENG} detected by the engine coolant temperature sensor 77 is higher than a threshold temperature T_{ENG1}. If it is determined NO at the step S27, the second routine R2 proceeds to the step S26 and the system takes the divided fuel injection mode as described above.

When it is determined at the step S27 that the engine temperature T_{ENG} detected by the engine coolant temperature sensor 77 is higher than the threshold temperature T_{ENG1}, the second routine proceeds to a step S28 and determines whether or not the intake air temperature T_{AIR} detected by the intake air temperature sensor 78 is higher than a threshold temperature T_{AIR1}. If it is determined NO at the step S28, the second routine R2 proceeds to the step S26 and the system takes the divided fuel injection mode as described above.

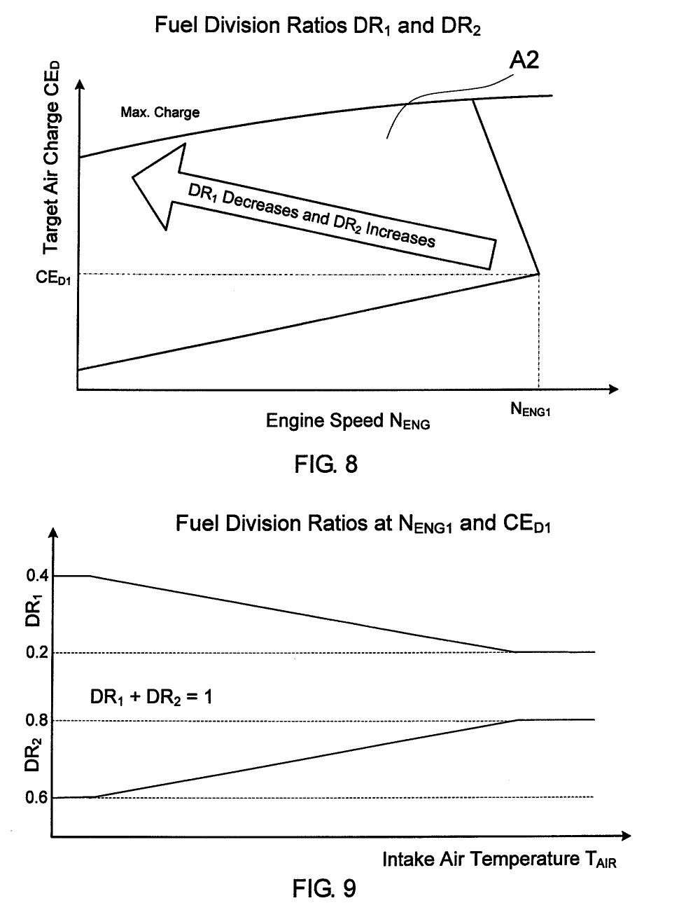

When it is determined at the step S28 that the intake air temperature T_{AIR} detected by the intake air temperature sensor 78 is higher than the threshold temperature T_{AIR1}, the second routine R2 proceeds to a step S29 and determines fuel division ratios DR1 and DR2 based on the target air charge CE_{D}, the engine speed N_{ENG} and the intake air temperature T_{AIR}. The determination is made by reading values stored in tables, one example of which is illustrated in FIG. 8. The table defines values within the area A2 in which the division ratio DR1 decreases and the division ratio DR2 increases as the target air charge CE_{D} increases or the engine speed N_{ENG} decreases while the division ratio DR2 is greater than the division ratio DR1 and a total of the division ratios DR1 and DR2 remains one (1).

Further, in one example, the tables are made to decrease the ratio DR1 and increase the ratio DR2 as the intake air temperature T_{AIR} is increases, or, in other words, as a temperature in the combustion chamber 17 increases, as shown in FIG. 9.

Referring back to FIG. 3, after the step S29, the second routine R2 proceeds to step S30 and calculates a fuel pressure P_{FUEL} to be equal to a higher pressure P2 which is greater than the constant, lower pressure P1. P2 may be constant, for example, 20 MPa, or P2 may increase as the intake air temperature T_{AIR} rises. Then, the second routine R2 proceeds to a step S31 and calculates first and second fuel pulse widths FP1 and FP2 as described below:

FP1=FP×P1/P2×DR1

FP2=FP×P1/P2×DR2.

Then, since DR1<DR2, the second fuel pulse width FP2 is greater than the first fuel width FP1. And, since DR1+DR2=1 and FP1+FP2=FP, the other fuel pulse widths FP0, FP3 and FP4 remain zero.

After the step S31, the second routine R2 returns. At step S8 of the first routine R1, the fuel system 54 is controlled to set fuel pressure at the higher pressure P2, and the fuel injector 53 is driven to open its nozzle at a predefined timing after the intake valve 21 opens. The nozzle is closed when the first pulse width FP1 has passed, for example, at 20° CA after the bottom dead center of the intake stroke, and again the nozzle is opened at a predetermined timing in a late compression stroke and closes when the second pulse width FP2 has passed, for example, at 20° CA before the top dead center of compression stroke, as is illustrated in the second bottom diagram of FIG. 7. Therefore, the system takes the intake and compression stroke injection mode, and the fuel injector 53 injects a lesser amount of first stage fuel that corresponds to the fuel first pulse width FP1 and a higher fuel pressure P2 during the intake stroke. The second stage fuel increases and corresponds to the second fuel pulse width FP2 and a higher fuel pressure P2 in a cylinder cycle. Then, after the top dead center of the compression stroke, the spark plug 51 delivers a spark and the first and second stage fuels are ignited.

The increased amount of the second stage fuel contributes to suppress the possibility of occurrence of pre-ignition as is described in greater detail below. It should also be noted that the ratio of the second stage fuel relative to the total of first and second stage fuel decreases as engine speed increases.

A graph of FIG. 8 illustrates a relationship between a maximum effective compression ratio with which no pre-ignition occurs and the percentage of the amount of the second stage fuel relative to the total amount of the first and second stage fuels. As is clear from FIG. 8, as the percentage of the second stage fuel becomes greater, the maximum effective compression ratio within the range in which no pre-ignition occurs becomes greater. When the percentage of the second stage fuel is 100%, it is most advantageous in maximizing the effective compression ratio.

On the other hand, a certain amount of the first stage fuel needs to be injected in consideration of the promotion of the vaporization or atomization of the fuel and uniform air fuel mixture inside of the cylinder. More specifically, the percentage of the second stage fuel amount may be preferably selected from 60% to 85%. In particular, the percentage of the second stage amount may be more preferably set to 75% or more (the percentage of the first stage fuel amount may be preferably 25% or less, for example, approximately ¼ or less, wherein 15% or more of the first stage injection quantity can be desirably secured).

The graph of FIG. 8 plots data obtained under test conditions described below. A spark ignited direct injection engine having a geometric compression ratio of 16 is used. An engine speed is 750 rpm (an idle speed for the engine was 650 rpm); the throttle valve 57 is fully opened; a heat range of the spark plug 51 is 6; an octane rating of the fuel (gasoline) is 96; a fuel pressure is 15 MPa; an engine coolant temperature is 80° C.; an intake air temperature is 25° C.; an absolute humidity is 7.5 g/m³; a timing of the end of the first stage fuel injection is 160° CA before the compression top dead center (20° CA after the intake bottom dead center); a timing of the end of the second stage fuel injection is 20° CA before the compression top dead center; an air fuel ratio is a stoichiometric air-fuel ratio; a closing timing of the exhaust valve 22 is 15° CA after the intake top dead center; a closing timing of the intake valve 21 is varied for changing the effective compression ratio; and an ignition timing is 15° CA after the compression top dead center, which is a sufficient delay for detecting the pre-ignition.

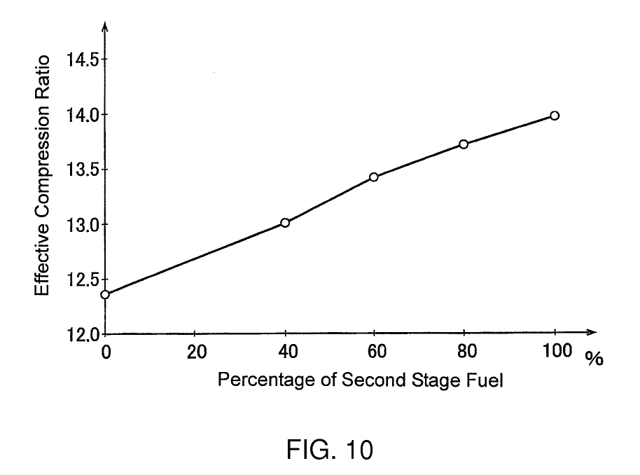

As can be seen from the graph of FIG. 10, the maximum effective compression ratio with which no pre-ignition occurs increases as the percentage of the second stage fuel amount was increased from 0% to 100% under the above-described test conditions. Therefore, the figure clearly shows the greater the percentage of second stage fuel amount relative to the total amount of the first and second stage fuel, the higher possibility of suppressing pre-ignition.

In the embodiment described above, when the engine operating condition is in the area A2 illustrated in FIG. 6, if the engine temperature T_{ENG} and the intake air temperature T_{AIR} are both higher than the threshold temperatures as is determined at the steps S22, S25, S27 and S28 of the second routine R2 in FIG. 3, the system takes the intake and compression stroke injection mode. Then, the first and second stage fuels are injected at the step S8 of the first routine R1 in FIG. 2 in accordance with the fuel division ratios DR1 and DR2 determined at the step S29 of the second routine R2.

As shown in FIG. 8, the fuel division ratio DR2 increases, which translates to increasing the ratio of the second stage fuel amount relative to the total fuel amount as expressed at the step S29 of the second routine R2, as the engine speed N_{ENG} decreases or the target air charge CE_{D} increases and the possibility of occurrence of the pre-ignition increases. Also, as shown in FIG. 9, the fuel division ratio DR2 increases as the intake air temperature T_{AIR} increases and the possibility of occurrence of the pre-ignition increases. On the other hand, when the possibility of occurrence of the pre-ignition decreases, the fuel division ratio DR1 increases which translates to increasing the ratio of the first stage fuel amount relative to the total fuel amount leading to the promotion of the evaporation or atomization of the fuel and a uniform air fuel mixture.

The higher fuel pressure in the intake and compression stroke injection mode contributes to enhance the atomization or evaporation of the first stage fuel. It also allows the second stage fuel to be injected in a shorter duration and secures the period for the atomization or evaporation of the second stage fuel until the spark ignition.

The spark ignition after the top dead center during a cylinder cycle in the intake and compression stroke injection mode contributes to suppress the possibility of occurrence of knocking.

Thus, the present description provides for a method of controlling a spark ignited internal combustion engine having a fuel injector which injects fuel directly into a combustion into a combustion chamber comprising; injecting a first stage of fuel in the combustion chamber during a cylinder cycle, the first stage of fuel injected by early in a compression stroke during the cylinder cycle, and injecting a second stage of fuel, after injecting the first stage of fuel, the second stage of fuel injected by late in the compression stroke during the cylinder cycle, the amount of the second stage fuel being greater than the amount of the first stage fuel. Wherein said second amount of fuel is increased in relation to an air charge amount, engine speed, and intake air temperature. In one example, the second fuel amount increases as intake temperature increases.

It is needless to say that this description is not limited to the illustrated embodiments, nor is the description limited to the various improvements described herein. Therefore, alternative designs are possible without departing from the substance of the description and claims.

For example, in the embodiment described above, when the engine operating condition is in the area A2 illustrated in FIG. 6, the first and second stage fuels are injected during a cylinder cycle only if it is determined at the step S28 of the second routine R2 that the intake air temperature T_{AIR} is higher than the threshold temperature T_{AIR1}. However, no matter how much higher the intake air temperature T_{AIR} is, the first and second stage fuel may be injected during a cylinder cycle if the engine temperature T_{ENG} is higher than the threshold temperature T_{ENG1}.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A method of controlling a spark ignited internal combustion engine having a fuel injector which injects fuel directly into a combustion chamber, comprising:
injecting a total amount of fuel into said combustion chamber during a cylinder cycle, said total amount of fuel injected by early in a compression stroke of said cylinder cycle at a first engine speed; and
injecting a first stage of fuel into said combustion chamber during a cylinder cycle, said first stage of fuel injected by early in a compression stroke of said cylinder cycle, and injecting a second stage of fuel, after injecting said first stage of fuel, said second stage of fuel injected by late in said compression stroke during said cylinder cycle at a second engine speed, said second engine speed less than said first engine speed, said first stage fuel and said second stage fuel injected at a desired engine torque that is greater than a threshold torque, and an amount of said second stage fuel being greater than an amount of said first stage fuel.

2. The method as described in claim 1, further comprising decreasing a ratio of said amount of said second stage fuel relative to the total amount of said first stage fuel and said second stage fuel as speed of said engine increases.

3. The method as described in claim 2, further comprising increasing a ratio of said amount of said second stage fuel relative to the total amount of said first and second stage fuel as a desired engine torque increases.

4. The method as described in claim 3, further comprising increasing a ratio of said amount of said second stage fuel relative to the total amount of said first and second stage fuel as a temperature in said combustion chamber increases.

5. The method as described in claim 4, further comprising igniting said first stage of fuel and said second stage of fuel with a spark after a top dead center of said compression stroke during said cylinder cycle when said second stage fuel is injected.

6. The method as described in claim 5, further comprising:
injecting fuel at a first pressure when said total amount of fuel is injected by early in said compression stroke of said cylinder cycle; and
injecting fuel at a second pressure which is greater than said first pressure when said second stage fuel is injected.

7. The method as described in claim 6, further comprising:
opening an intake valve of said combustion chamber after closing an exhaust valve of said combustion chamber; and
injecting said first stage fuel after said opening of said intake valve.

8. The method as described in claim 1, further comprising increasing a ratio of said amount of said second stage fuel relative to the total amount of said first stage fuel and said second stage fuel as said desired torque increases.

9. The method as described in claim 8, further comprising increasing a ratio of said amount of said second stage fuel relative to the total amount of said first stage fuel and said second stage fuel as a temperature in said combustion chamber increases.

10. The method as described in claim 9, further comprising igniting said first stage fuel and said second stage fuel with a spark delivered after a top dead center of said compression stroke.

11. The method as described in claim 10, further comprising:
injecting fuel at a first pressure when said total amount of fuel is injected by early in said compression stroke of said cylinder cycle; and
injecting fuel at a second pressure which is greater than said first pressure when said second stage fuel is injected.

12. The method as described in claim 11, further comprising:
opening an intake valve of said combustion chamber after closing an exhaust valve of said combustion chamber; and
injecting said first stage fuel after said opening of said intake valve.

13. The method as described in claim 1, further comprising increasing a ratio of said amount of said second stage fuel relative to the total amount of said first stage fuel and second stage fuel as a temperature in said combustion chamber increases.

14. The method as described in claim 13, further comprising igniting said first stage fuel and said second stage fuel with a spark delivered after a top dead center of said compression stroke.

15. The method as described in claim 14, further comprising:
injecting fuel at a first pressure when said total amount of fuel is injected by early in said compression stroke of said cylinder cycle; and
injecting fuel at a second pressure which is greater than said first pressure when said second stage fuel is injected.

16. The method as described in claim 15, further comprising:
opening an intake valve of said combustion chamber after closing an exhaust valve of said combustion chamber; and
injecting said first stage fuel after said opening of said intake valve.

17. The method as described in claim 1, further comprising igniting said first stage fuel and said second stage fuel with a spark delivered after a top dead center of said compression stroke.

18. The method as described in claim 1, further comprising:
injecting fuel at a first pressure when said total amount of fuel is injected by early in said compression stroke of said cylinder cycle; and
injecting fuel at a second pressure which is greater than said first pressure when said second stage fuel is injected.

19. A system comprising:
a spark ignited internal combustion engine;
a fuel injector which injects fuel directly into a combustion chamber; and
a controller configured to control said fuel injector to:
inject a total amount of fuel into said combustion chamber during a cylinder cycle, said total amount of fuel injected by an early in a compression stroke of said cylinder cycle at a first engine speed; and
inject a first stage of fuel into said combustion chamber during a cylinder cycle, said first stage of fuel injected by early in a compression stroke of said cylinder cycle, and injecting a second stage of fuel, after injecting said first stage of fuel, said second stage of fuel injected by late in said compression stroke during said cylinder cycle at a second engine speed, said second engine speed less than said first engine speed, and said first stage fuel and said second stage fuel injected at a desired engine torque that is greater than a threshold torque, and an amount of said second stage fuel being greater than an amount of said first stage fuel.

20. The system as described in claim 19, wherein said spark ignited internal combustion engine has a geometric compression ratio of 14 or greater.
